(19) United States
(12) Patent Application Publication
(10) Pub. No.: US 2023/0366255 A1
(43) Pub. Date: Nov. 16, 2023

(54) Safe Box With Real Time Tracking System For Parcel Shipment

(71) Applicant: Andrea Dal Farra, Boca Raton, FL (US)

(72) Inventor: Andrea Dal Farra, Boca Raton, FL (US)

(21) Appl. No.: 18/196,726

(22) Filed: May 12, 2023

Related U.S. Application Data
(60) Provisional application No. 63/342,585, filed on May 16, 2022.

(51) Int. Cl. E05G 1/00; G06Q 10/0833; E05G 1/10; E05G 1/12

(52) U.S. Cl. CPC E05G 1/005; G06Q 10/0833; E05G 1/10; E05G 1/12

(57) ABSTRACT

A safe box specially designed for shipping, through a regular courier, high value or collectible items with a wide range of sensors, including GPS, a light sensor, temperature sensor, microphone, camera, motion sensor, speaker, hygrometer, monitored locking system, network module, battery module, and anti-theft mechanisms to detect and prevent theft or unauthorized access. The battery module provides power to the network module and the sensors. The sensors providing location information and data to the network module, the network module transmits a shipping status message to an external device.

### CROSS-REFERENCE TO RELATED APPLICATIONS

This application relates back to U.S. 63/342,585 filed on May 16, 2022 and is incorporated in its entirety.

### PRIOR ART

While safes are well known in the prior art such as US 2012/0298018 or WO 2018/222157, these are not intended to be used in the context of standard shipping routes.

The disclosed device is unique when compared with other known devices and solutions because:
(1) The present subject matter permits the user to control in real time the status of the valuable shipped items inside the package;
(2) The present subject matter will provide real time alert message when out of the delivery route or unauthorized unboxing or unauthorized opening occur;
(3) The present subject matter will record all the series of data to help investigators track any thief; and
(4) The present subject matter will deploy the anti-theft system in case of theft detection, making it difficult to extract the object in a short period of time, giving the users more time to track and recover the safebox.

All these features will play a fundamental role as deterrent, saving insurance cost and protecting valuable items (like collectible and unique items) from thieves. In case of theft, police can track the package in real time before it's opening.

### BACKGROUND OF THE INVENTION

Conventional package tracking is well known in the art, being used by postal services, couriers, and other shipping and delivery services, to determine the location of a package. A package, or box is assigned a tracking number or code when it is first given by a sender to the delivery service. Typically, a barcode is affixed to the package and may be scanned with an optical reader. Alternatively, other technology such as magnetic strips, Radio frequency identification (RFID) or Near-field communication (NFC) tags may be used.

At key points in the package's journey to its destination, the package is scanned, with the location and progress of the package being made available to anyone with the barcode. When the package is delivered to the receiver, it is scanned one final time and the receiver may be required to provide a signature.

There are several drawbacks with presently used technology. One is that packages are only scanned at predefined points in their journey. Another is that once a package is marked as delivered, it is no longer tracked. If it has been delivered to the wrong location or signed by the wrong person, it is easy for the package to become lost. Additionally, if a package is opened on route or tampered with, this is not detected by the scanning process.

With package theft becoming an increasing issue, there is currently no way for a sending or receiving party or shipping company to verify whether each person picking up a package is an authorized courier or receiving party or to identify who is opening a package after it has been delivered. In addition to package theft, with the continuing growth in Internet retail, e-commerce, overnight shipping and same day delivery, there is also a huge growth in misplaced packages and package returns and there is presently no way to automatically re-route packages once they are en route other than to return a package to the sender.

Existing wireless package identification systems such as Radio Frequency Identification (RFID) tags and Near Field Communication (NFC) are limited in the amount of data that may be transmitted and the signal strength and close proximity necessary to receive the RFID or NFC signal and both have significant limitations in real-time data, self-tracking and self-reporting and peer-to-peer networking capabilities.

There are a few solutions for shipping valuable items. Some of these solutions attempt to offer geo-localization of the package, but these solutions fail to meet the needs of the industry because they don't offer a theft-proof case and anti-theft system, the packaging is too weak and easy to open.

Existing package tracking and networking systems such as GPS tracking devices that may be placed inside of a package to continuously monitor package location and may also include motion, shock, temperature and other sensors and wireless data uploading via a Cellular or LAN network are presently designed to track a single package with limited or no peer-to-peer wireless package networking, identification and verification capabilities as well as limited or no external package monitoring, audio-video and data streaming, bi-directional or multi-channel communications nor they provide an anti-theft system with monitored locking system.

Other solutions attempt to offer security cases, but these solutions are similarly unable to meet the needs of the industry because they do not offer real-time data (location and status) and the curriers portal is often not updated with accurate data.

While the above described devices fulfill their respective, particular objectives and requirements, the aforementioned patents do not describe a precise statistics computation for communication networks that allows for tracking or monitoring of a device or package using condition detection and notification nor offer a high protection case with anti-theft system and monitored locking system. There exists a need for an economical high protection packaging with active tracking, tamper detection solution and anti-theft system to improve the security and reliability of the shipping of highly valuable packages.

To solve this problem, our safe box is a combination of a safe packaging with anti-theft system to ship your valuable items with a complex electronic board able to control and transmit the status and location of the box in real time thru network data communication in order to offer you safety and control about every aspect of the shipment for the peace of mind when shipping high valuable items.

### SUMMARY OF THE INVENTION

In view of the foregoing disadvantages inherent in the known types of package tracking systems now present in the prior art, the present technology provides a novel and secure shipping solution for high value items, and overcomes one or more of the mentioned disadvantages and drawbacks of the prior art. As such, the general purpose of the present technology, which will be described subsequently in greater detail, is to provide a new and novel, reusable, shipping packaging with tracking and monitoring system which has all the advantages of the prior art mentioned heretofore and many novel anti-theft features that result in a shipping packaging with tracking and monitoring system which is not anticipated, rendered obvious, suggested, or implied by the prior art, either alone or in any combination thereof.

There is a need to have a safe box with a tracking system in real time which allows the shipper to secure and track their valuable items during the shipment and the delivery. Furthermore, it would be desirable to have a safe box with a tracking system that's allow the control in real time of the location of the package and the status of the package.

There is also a need to have a Safebox with a tracking system that allows the user to protect and secure your items during the shipment with a good grade of protection. The disclosed device advantageously fills these needs and addresses the aforementioned deficiencies by providing a sturdy packaging with anti-theft system that can allow the sender to monitor and secure their valuable items during the shipping period till when it's delivered to the final client.

Disclosed is a safe box with tracking device, which is made up of the following components: a base (secure container where place the valuable items to ship) and the lid with all the electronics sensors, the anti-theft system, and the monitored locking system. These components are related to each other as follows: a shipping packaging comprising an enclosure (base) for receiving content, a closure (lid) for sealing the enclosure with a network module, a sensor module, an anti-theft module and a battery module. The battery module provides power to the network module and the sensor module. The sensor module provides location information and sensor data to the network module. The network module transmits a shipping status and data message to an external network. The network may support any one or several protocols as is known in the art including IEEE 802 Wi-Fi, cellular networks, Bluetooth, RFID, NFC, and others. As the smart package is aware of its location, it may be configured to automatically go into “airplane mode” when in an aircraft. It may also automatically disable wireless interfaces that may not be required when it is in a vehicle, container, or building where it is in wireless contact with its immediate surroundings and uses networking hardware in the surroundings as a router, access point, or hub.

In many cases, smart packages may connect to a central server or service such as a shipping or delivery company. The shipper, receiver, or other authorized parties are also able to receive package status updates either directly from the package, via a package tracking website, platform, software application or through the shipping company's website. Updates, status changes, and alerts may be queried by external networked devices, be reported by the smart package itself, be logged locally or remotely, or a combination of these methods.

The lid hosts several sensors, like GPS sensor, light sensor (to alert the unpacking), anti-theft device, microphone (to register the voices in case of theft), speaker (to play voice and alarm messages), camera (to record faces in case of theft), a wireless base charger to charge the battery if the level of charge it's low, a key socket to open the lid in case of electronic failure, a reset button in case of software reboot is needed, a touchscreen display to interface with the users (show alarms or a pin pad where tap the password to unlock the device), a g-force sensor to detect tampering. The safe box will be electronically operated, and power is supplied by rechargeable battery.

Any detected theft of a package can also trigger events, such as the disabling of electronics in the packaged device, the activation of alert systems and anti-theft system, including audible or light alarms on or in the packaging, or in the carrying vehicle or storage space, alert transmission via Cellular, Wi-Fi, Bluetooth, NFC or other remote, wide area, local area and short-distance means to local security or carrier staff or to other agents via the Internet, or the automatic transmission of the thief's IP address and GPS coordinates over a network by the stolen devices, as soon as it is connected to the internet (since the smart package is an IoT—Internet of Things—device). An alert transmission may also be triggered if a package leaves its pre-assigned travel route or may be assigned to intermittently send out transmissions at pre-set time intervals or at pre-set locations of the packages. A shipper or shipping company may assign the shipping and destination locations or additional shipping information such as air, ground or sea transportation routes and assign designated shipping centers and methods such as which airplane, delivery truck and or delivery agent the package is assigned to, and any changes in the shipping route, method or delivery agent will automatically trigger an alert.

In some embodiments, the device may also have one or more of the following:
a set of different bases to fit different standard packaging size from each courier;
an internal camera to witness the inserting of the items till the closing of the lid, the lock will be electronically monitored to control that it will remain closed all the time till authorized unpacking;
a waterproof and bulletproof case material;
a fireproof case material;
a speaker in order to provide instructions to a person in the vicinity or for other purposes. When combined with a microphone, this may allow for voice communications between the shipper, receiver, service provider and other interested or authorized parties;
an anti-theft system that deploys ink or smoke or anti-theft foam; and
an anti-jammer device to protect the GPS and data transmission against jamming; The disclosed device is unique in that it is structurally different from other known devices or solutions. More specifically, the device is unique due to the presence of (1) more sensors and electronics that allow the user to have the full control in real time of the package; (2) more performing structure to secure the internal items against water, fire and other weather condition (too hot or too cold) and against theft.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The Safebox with real time tracking system for parcel shipment may, however, be embodied in many different forms and should not be construed as being limited to the embodiments set forth herein; rather, these embodiments are provided by way of illustration only and so that this disclosure will be thorough, complete and fully convey understanding to those skilled in the art.

### DESCRIPTION OF DRAWINGS

FIG. 1 shows a perspective view of the safe box's base (container) without the lid.

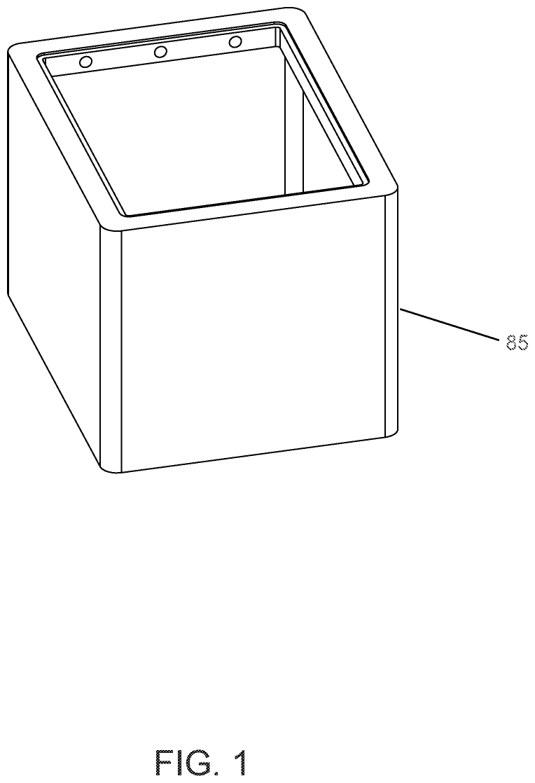

FIG. 2 shows a top perspective view of the lid without the base.

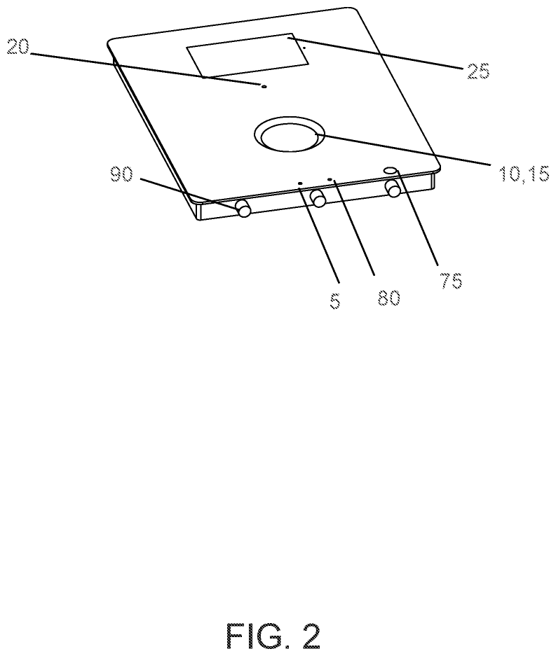

FIG. 3 shows a bottom perspective view of the lid without the base.

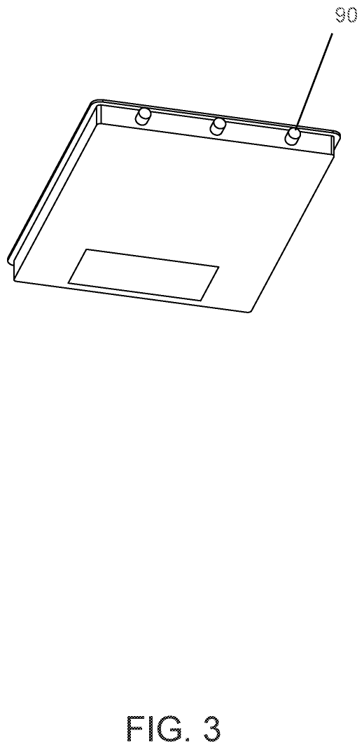

FIG. 4 shows an exploded view of the present subject matter with the internal components displayed.

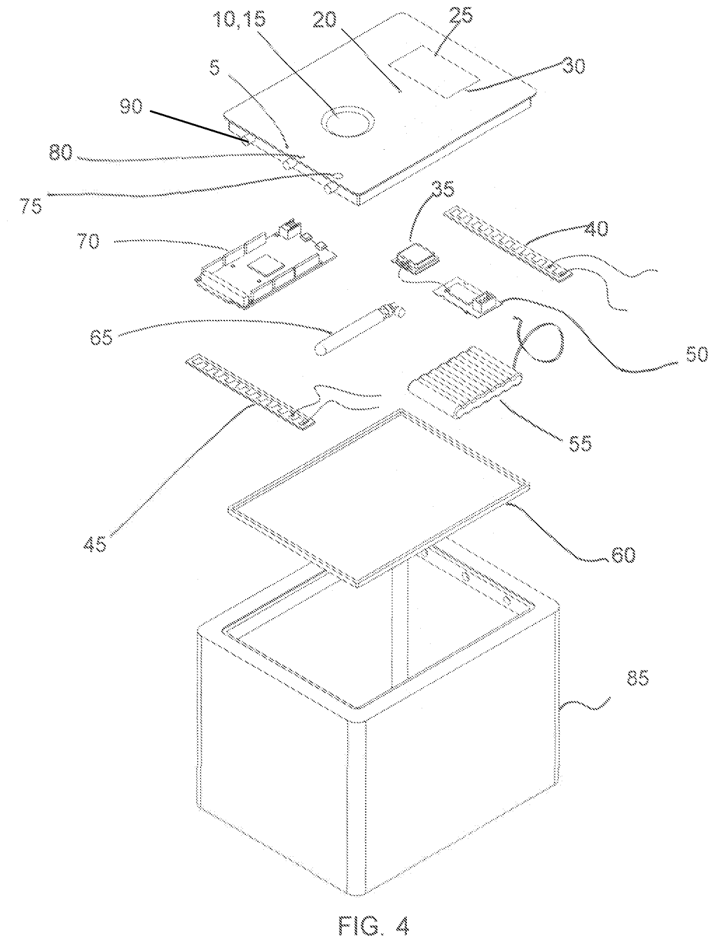

### DETAILED DESCRIPTION OF THE INVENTION

The present subject matter is directed to ship the safe box with real time tracking system for high value parcel shipment. In its most complete version, the device is made up of the following components:
a safe box base (container) made from bulletproof and fireproof material;
a safe box lid with all the electronic system and mechanical lock to secure the whole safe box.

These components are related as follows: the lid will fit perfectly in the case sealing it, with waterproof protection, fireproof protection, and bullet proof protection. It should further be noted that: the whole system will be electronically operated through a web platform and dedicated mobile app. Once the safe box is armed, the lock mechanism will keep your items secured and safe until the authorized unpacking at destination.

The safe box has the following capabilities:
G.P.S. position to check in real time the location of the safe box during the transit.

Light sensor to check if the safe box is still inside the outer cardboard box or if its unpacked without authorization (before the delivery set point).

Microphone to record the sound and voices in case of theft.

Camera to record the faces of the thief in case of unauthorized unpacking from the outer box.

Motion sensor to monitor the g-force in case of damage.

Speaker to play alarms or communicate messages.

Thermometer to activate the internal temperature control system (cooling or heating).

Hygrometer sensor to activate the humidity control.

Touch screen display to run alarms message or keypad to unlock the safe box.

Anti-theft device with foam, ink, or smoke for auto deployment in case of unauthorized opening.

All the features are operated and managed online through a cloud dedicated portal.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments.

It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

### LEGEND FOR FIGS

5—Microphone
10—Charger
15—Speaker
20—Video Camera
25—Display Touch Screen
30—Reset Button
35—GPS
40, 45—Heating Pad For Temperature Control
50—G-force Sensor
55—Battery
60—Lid Cover
65—Anti Theft Foam Dispenser
70—Electronic Board
75—Manual Lock Socket
80—Light Sensor
85—Base
90—Locking System

1. A safe box with real time tracking system for parcel shipment specially designed for shipping high value or collectible items comprising of a wide range of sensors, including GPS, a light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access.

2. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the safe box is made of bullet proof and fireproof material.

3. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein GPS tracks the real time position of the box during transportation.

4. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the light sensor detects if the safe box is still inside of the outer cardboard box.

5. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein a microphone records voices in the event of theft.

6. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the camera records any faces or presence of people in the event of an unauthorized opening of the outer cardboard box.

7. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the motion sensor detects changes in g-force to detect damages.

8. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the speaker is used to sound an alarm or play messages in the event of an unauthorized opening of the outer cardboard box.

9. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the thermometer is used to activate the internal temperature control system.

10. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the touch screen display allows for an alarm message to run during an unauthorized opening or to act as a keypad to access the inside of the safe box.
The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the anti-theft mechanism is foam, ink, or smoke for auto deployment in case of unauthorized opening.

11. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein features are operated and managed online through a cloud dedicated portal.

12. The safe box specially designed for shipping high value or collectible items comprising of the wide range of sensors, including GPS, light sensor, microphone, camera, motion sensor, speaker, hygrometer, thermometer, internal temperature control system, online portal, touch screen display, rechargeable battery, monitored locking system, and anti-theft mechanisms to detect and prevent theft or unauthorized access as in claim 1, wherein the rechargeable battery may be charged through a wireless charging connection.
